(19) United States
(12) Patent Application Publication
(10) Pub. No.: US 2026/0158858 A1
(43) Pub. Date: Jun. 11, 2026

(54) METHOD AND APPARATUS FOR CONTROLLING VENTILATION OF A VEHICLE CARGO COMPARTMENT

(71) Applicants: HYUNDAI MOTOR COMPANY, Seoul (KR); KIA CORPORATION, Seoul (KR)

(72) Inventors: Hyunseon Chae, Hwaseong-si (KR); Sae Yong Jang, Hwaseong-si (KR); Minju Kim, Hwaseong-si (KR)

(73) Assignees: HYUNDAI MOTOR COMPANY, Seoul (KR); KIA CORPORATION, Seoul (KR)

(21) Appl. No.: 19/377,690

(22) Filed: Nov. 3, 2025

(30) Foreign Application Priority Data
Dec. 10, 2024 (KR) 10-2024-0182221

(51) Int. Cl. B60H 1/00

(52) U.S. Cl. CPC B60H 1/00828; B60H 1/008

(57) ABSTRACT

In a method for controlling ventilation of a vehicle cargo compartment according to an external environment, location information of the vehicle is transmitted to a remote server. A first remote data indicating whether an automatic ventilation control is activated, a second remote data indicating a battery condition, a third remote data including information on a delivery zone, and a first local data indicating a battery state of the vehicle are received. An operation mode of ventilation control is set to a first operation mode is set based on the received data. A command is transmitted to an integrated vehicle controller provided in the vehicle to control ventilation of the vehicle cargo compartment according to the operation mode of the ventilation control set based on the received data.

### CROSS-REFERENCE TO RELATED APPLICATION

This application claims priority to and the benefit of Korean Patent Application No. 10-2024-0182221 filed with the Korean Intellectual Property Office on Dec. 10, 2024, the entire contents of which are hereby incorporated herein by reference.

### BACKGROUND

### (a) Technical Field

The present disclosure relates to a method and apparatus for controlling ventilation of a vehicle cargo compartment. More particularly, the present disclosure relates to a ventilation control method and apparatus capable of automatically controlling ventilation of the vehicle cargo compartment according to the external environment.

### (b) Description of the Related Art

In the process of transporting various types of goods by loading them into the cargo compartment of a logistics vehicle, there is a possibility that any smell or bugs remaining inside the cargo compartment may have a negative effect on other goods. For example, when transporting sensitive goods such as clothing or room-temperature food, foul odors or bugs from previously loaded goods may remain, which may cause quality deterioration during transport. These issues can lead to consumer dissatisfaction and negatively affect the reliability and service quality of the logistics company.

The statements in this Background section merely provide background information related to the present disclosure and may not constitute prior art.

### SUMMARY

Embodiments of the present disclosure provide a method and apparatus for controlling ventilation of a vehicle cargo compartment capable of controlling (e.g., automatically controlling) ventilation of the cargo compartment by considering the external environment, thereby maintaining good air quality in the cargo compartment, and preventing problems such as odor and pests that may occur during the logistics process.

Embodiments of the present disclosure provide a method and apparatus for controlling ventilation of a vehicle cargo compartment that ensure that the interior environment of the cargo compartment of a logistics vehicle is kept hygienic and comfortable.

According to an embodiment, a method for controlling ventilation of a vehicle cargo compartment of a vehicle according to an external environment is provided. The method includes transmitting, by a processor of the vehicle to a remote server, location information of the vehicle obtained from a location detecting device provided in the vehicle. The method also includes receiving, by the processor, a first remote data indicating whether an automatic ventilation control is activated, a second remote data indicating a battery condition, and a third remote data including information on a delivery zone. The method additionally includes receiving, by the processor, a first local data indicating a battery state of the vehicle. The method further includes determining, by the processor, whether a value of the first remote data indicates an activation of the automatic ventilation control. The method also includes determining, by the processor, whether the battery state indicated by the first local data satisfies the battery condition indicated by the second remote data, based on determining that the value of the first remote data indicates the activation of the automatic ventilation control. The method additionally includes setting, by the processor, an operation mode of ventilation control to a first operation mode, based on determining that the battery state of the vehicle of the first local data satisfies the battery condition of the second remote data. The method further still includes setting, by the processor, the operation mode of the ventilation control to a second operation mode, based on determining one or both of i) that the value of the first remote data indicates an inactivation of the automatic ventilation control or ii) that the battery state of the vehicle indicated by the first local data does not satisfy the battery condition indicated by the second remote data. The method additionally includes transmitting, by the processor, a command to an integrated vehicle controller provided in the vehicle to control the ventilation of the vehicle cargo compartment according to the operation mode of the ventilation control.

Transmitting the command to the integrated vehicle controller may include transmitting, by the processor, a command to control the ventilation of the vehicle cargo compartment by setting a ventilation mode to an outside air mode, based on setting the operation mode of the ventilation control to the first operation mode.

Transmitting the command to the integrated vehicle controller may include transmitting, by the processor, a command to control the ventilation of the vehicle cargo compartment by setting a ventilation mode to an internal air circulation mode, based on setting the operation mode of the ventilation control to the second operation mode.

The information on the delivery zone included in the third remote data may include information indicating a region in a vicinity of a garage location and a delivery location. The method may further include: determining, by the processor, whether a current delivery zone of the vehicle corresponds to the region in the vicinity of the garage location and the delivery location indicated by the third remote data; switching, by the processor, the operation mode of the ventilation control from the first operation mode to a third operation mode for not performing ventilation of the vehicle, based on determining that the current delivery zone of the vehicle corresponds to the region in the vicinity of the garage location and the delivery location indicated by the third remote data; and transmitting, by the processor, a command to the integrated vehicle controller to control the ventilation of the vehicle cargo compartment according to the third operation mode.

The method may further include: receiving, by the processor, a fourth remote data indicating a weather condition; determining, by the processor, whether current weather during driving of the vehicle corresponds to the weather condition indicated by the fourth remote data; switching, by the processor, the operation mode of the ventilation control from the first operation mode to the second operation mode, based on determining that the current weather during driving the vehicle corresponds to the weather condition indicated by the fourth remote data; and transmitting, by the processor, a command to the integrated vehicle controller to control the ventilation of the vehicle cargo compartment according to the second operation mode.

The method may further include: receiving, by the processor, a second local data indicating a refrigerator connection status of the vehicle; switching, by the processor, the operation mode of the ventilation control from the first operation mode to the second operation mode, based on determining that a value of the second local data indicates that a refrigerator is connected; and transmitting, by the processor, a command to the integrated vehicle controller to control the ventilation of the vehicle cargo compartment according to the second operation mode.

The method may further include: receiving, by the processor, a third local data indicating driving state of the vehicle; determining, by the processor, whether a value of the third local data exceeds a predetermined reference speed; and transmitting, by the processor, a command to the integrated vehicle controller to open a door of a ventilation fan and operate the ventilation fan, for the ventilation of the vehicle cargo compartment, based on determining that the value of the third local data exceeds the predetermined reference speed.

Transmitting the command to the integrated vehicle controller may further include transmitting, by the processor, a command to open the door of the ventilation fan but not operate the ventilation fan, for the ventilation of the vehicle cargo compartment, based on determining that the value of the third local data is less than or equal to the predetermined reference speed.

The method may further include: receiving, by the processor, a fourth local data indicating an air pollution level, when the operation mode of the ventilation control is the first operation mode; determining, by the processor, whether the air pollution level indicated by the fourth local data is higher than a predetermined reference pollution level′ and transmitting, by the processor, a command to the integrated vehicle controller to additionally perform an air cleaning control with respect to the vehicle cargo compartment, based on determining that the air pollution level of the fourth local data is higher than the reference pollution level.

The method may further include: receiving, by the processor, a fifth local data indicating a fine dust level, when the operation mode of the ventilation control is the first operation mode; determining, by the processor, whether the fine dust level indicated by the fifth local data is higher than a predetermined fine dust reference level; and transmitting, by the processor, a command to the integrated vehicle controller to additionally perform an air cleaning control with respect to the vehicle cargo compartment, based on determining that the fine dust level of the fifth local data is higher than the predetermined fine dust reference level.

According to another embodiment, an apparatus for controlling ventilation of a vehicle cargo compartment according to the external environment is provided. The apparatus includes one or more non-transitory computer-readable media including computer-readable instructions stored thereon. The apparatus also includes one or more processors configured to execute the computer-readable instructions to: transmit location information of the vehicle, obtained from a location detecting device provided in the vehicle, to a remote server via a communication interface; receive a first remote data indicating whether an automatic ventilation control is activated, a second remote data indicating a battery condition, and a third remote data including information on a delivery zone, via the communication interface or a vehicle interior network; receive a first local data indicating a battery state of the vehicle, via the vehicle interior network; determining whether a value of the first remote data indicates an activation of the automatic ventilation control; determine whether the battery state indicated by the first local data satisfies the battery condition indicated by the second remote data, based on determining that the value of the first remote data indicates the activation of the automatic ventilation control; set an operation mode of the ventilation control to a first operation mode, based on determining that the battery state of the vehicle indicated by the first local data satisfies the battery condition indicated by the second remote data; set the operation mode of the ventilation control to a second operation mode, based on determining one or both of i) that the value of the first remote data indicates an inactivation of the automatic ventilation control or ii) that the battery state of the vehicle indicated by the first local data does not satisfy the battery condition indicated by the second remote data; and transmitting a command to an integrated vehicle controller provided in the vehicle to control ventilation of the vehicle cargo compartment in according to the operation mode of the ventilation control.

The one or more processors may be configured to transmit the command the integrated vehicle controller to control the ventilation of the vehicle cargo compartment by setting a ventilation mode to an outside air mode, based on setting the operation mode of the ventilation control to the first operation mode.

The one or more processors may be configured to transmit the command to the integrated vehicle controller to control the ventilation of the vehicle cargo compartment by setting a ventilation mode to an internal air circulation mode, based on setting the operation mode of the ventilation control to the second operation mode.

The information on the delivery zone of the third remote data may include information indicating a region in a vicinity of a garage location and a delivery location. The one or more processors are further configured to execute the computer-readable instructions to: determine whether a current delivery zone of the vehicle corresponds to the region in the vicinity of the garage location and the delivery location indicated by the third remote data; switch the operation mode of the ventilation control from the first operation mode to a third operation mode for not performing the ventilation of the vehicle, based on determining that the current delivery zone of the vehicle corresponds to the region in the vicinity of the garage location and the delivery location indicated by the third remote data; and transmit, by the processor, a command to the integrated vehicle controller to control the ventilation of the vehicle cargo compartment according to the third operation mode.

The one or more processors are further configured to execute the computer-readable instructions to: receive a fourth remote data indicating a weather condition, via the communication interface or the vehicle interior network; determine whether a current weather during driving of the vehicle corresponds to the weather condition indicated by the fourth remote data; switch the operation mode of the ventilation control from the first operation mode to the second operation mode, based on determining that the current weather during driving of the vehicle corresponds to the weather condition indicated by the fourth remote data; and transmit a command to the integrated vehicle controller to control the ventilation of the vehicle cargo compartment according to the second operation mode.

The one or more processors are further configured to execute the computer-readable instructions to: receive a second local data indicating a refrigerator connection status of the vehicle, via the vehicle interior network; switch the operation mode of the ventilation control from the first operation mode to the second operation mode, based on determining that that a value of the second local data indicates that a refrigerator is connected; and transmit a command to the integrated vehicle controller to control the ventilation of the vehicle cargo compartment according to the second operation mode.

The one or more processors are further configured to execute the computer-readable instructions to: receive a third local data indicating driving state of the vehicle, via the vehicle interior network; determine whether a value of the third local data exceeds a predetermined reference speed; transmit a command to the integrated vehicle controller to open a door of a ventilation fan and operate the ventilation fan, for the ventilation of the vehicle cargo compartment, based on determining that the value of the third local data exceeds the predetermined reference speed; and transmit a command to the integrated vehicle controller to open the door of the ventilation fan but not operate the ventilation fan, for the ventilation of the vehicle cargo compartment, based on determining that the value of the third local data is less than or equal to the predetermined reference speed.

The one or more processors are further configured to execute the computer-readable instructions to: receive a fourth local data indicating an air pollution level, via the vehicle interior network, when the operation mode of the ventilation control is the first operation mode; determine whether the air pollution level indicated by the fourth local data is higher than a predetermined reference pollution level; and transmit a command to the integrated vehicle controller to additionally perform an air cleaning control with respect to the vehicle cargo compartment, based on determining that the air pollution level indicated by the fourth local data is higher than the predetermined reference pollution level.

The one or more processors are further configured to execute the computer-readable instructions to: receive a fifth local data indicating a fine dust level, via the vehicle interior network, when the operation mode of the ventilation control is the first operation mode; determine, by the processor, whether the fine dust level indicated the fifth local data is higher than a predetermined fine dust reference level; and transmit a command to the integrated vehicle controller to additionally perform an air cleaning control with respect to the vehicle cargo compartment, based on determining that the fine dust level indicated by the fifth local data is higher than the predetermined fine dust reference level.

According to yet another embodiment, one or more non-transitory computer-readable media having computer-readable instruction stored thereon are provided. The computer-readable instructions, when executed by one or more processors, cause the one or more processors to: transmit location information of a vehicle, obtained from a location detecting device provided in the vehicle, to a remote server; receive a first remote data indicating whether an automatic ventilation control is activated, a second remote data indicating a battery condition, and a third remote data including information on a delivery zone; receive a first local data indicating a battery state of the vehicle; determine whether a value of the first remote data indicates an activation of the automatic ventilation control; determine whether the battery state of the first local data satisfies the battery condition of the second remote data, based on determining that the value of the first remote data indicates the activation of the automatic ventilation control; set an operation mode of the ventilation control to a first operation mode, based on determining that the battery state of the vehicle of the first local data satisfies the battery condition of the second remote data; set the operation mode of the ventilation control to a second operation mode, based on determining one or both of i) that the value of the first remote data indicates an inactivation of the automatic ventilation control or ii) that the battery state of the vehicle of the first local data does not satisfy the battery condition of the second remote data; and transmit a command to an integrated vehicle controller provided in the vehicle to control the ventilation of the vehicle cargo compartment according to the operation mode of the ventilation control.

### BRIEF DESCRIPTION OF THE DRAWINGS

FIG. 1 is a drawing for explaining an apparatus for controlling ventilation of a vehicle cargo compartment according to an embodiment.

FIG. 2 is a drawing for explaining a method for controlling ventilation of a vehicle cargo compartment according to an embodiment.

FIG. 3 is a drawing for explaining further details of the method for controlling ventilation of a vehicle cargo compartment according to an embodiment.

FIG. 4 is a drawing for explaining further details of the method for controlling ventilation of a vehicle cargo compartment according to an embodiment.

FIG. 5 is a drawing for explaining further details of the method for controlling ventilation of a vehicle cargo compartment according to an embodiment.

FIG. 6 is a drawing for explaining further details of the method for controlling ventilation of a vehicle cargo compartment according to an embodiment.

FIG. 7 is a drawing for explaining further details of the method for controlling ventilation of a vehicle cargo compartment according to an embodiment.

FIG. 8 is a drawing for explaining further details of the method for controlling ventilation of a vehicle cargo compartment according to an embodiment.

FIG. 9 is a drawing for explaining a computing device according to an embodiment.

### DETAILED DESCRIPTION

Embodiments of the present disclosure are described in more detail hereinafter with reference to the accompanying drawings, in which embodiments of the present disclosure are shown. As those having ordinary skill in the art should realize, the described embodiments may be modified in various different ways, all without departing from the spirit or scope of the present disclosure. Accordingly, the drawings and description should be regarded as illustrative in nature and not restrictive. Like reference numerals designate like elements throughout the specification and the accompanying drawings.

Throughout the specification and claims, when a part “includes” a certain element, it means that other elements may be further included, rather than excluding other elements, unless otherwise stated. Terms including ordinal numbers such as first, second, and the like may be used to describe various constituent elements. The terms are used to differentiate one constituent element from other constituent elements. These terms should not be interpreted as limiting the constituent elements.

In addition, terms such as “ . . . part,” “ . . . portion,” “ . . . er/or,” or “module” in the present specification may mean a unit that may process at least one function or operation described in this specification, and this may be implemented by hardware, software, or a combination thereof. In addition, according to embodiments described below, at least a partial configuration or function of a capable of controlling ventilation of the vehicle cargo compartment according to the external environment may be implemented as a program or software, and the program or software may be stored in a computer-readable recording medium or storage medium.

When a component, controller, device, element, unit, apparatus, or the like of the present disclosure is described as having a purpose or performing an operation, function, or the like, the component, controller, device, element, unit, apparatus, or the like should be considered herein as being “configured to” meet that purpose or to perform that operation or function. Each component, controller, device, element, unit, apparatus, and the like may separately embody or be included with a processor and a memory, such as a non-transitory computer readable media, as part of the apparatus.

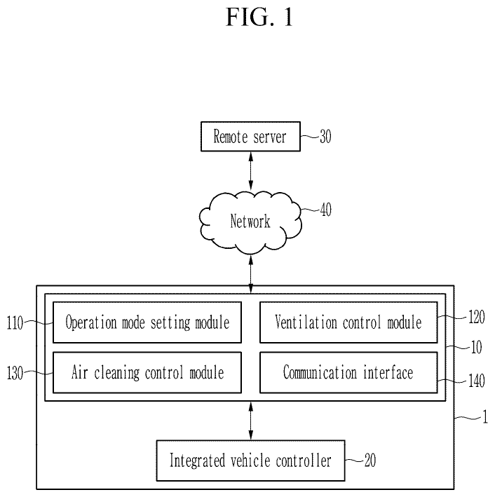

FIG. 1 is a drawing for explaining an apparatus for controlling ventilation of a vehicle cargo compartment according to an embodiment.

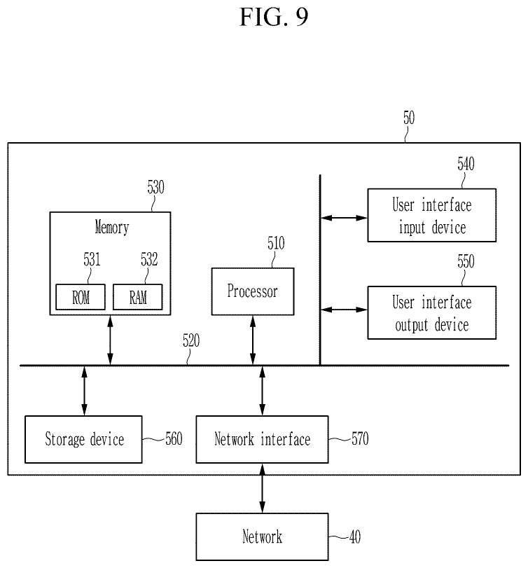

Referring to FIG. 1, a ventilation control apparatus 10 for controlling ventilation of a vehicle cargo compartment according to an embodiment may be implemented as a computing device including one or more processors and one or more memories. For example, the ventilation control apparatus 10 may be implemented by a computing device 50 described below with reference to FIG. 9. In an embodiment, the computing device 50 may be implemented in a vehicle 1. For example, the computing device 50 may be implemented as a controller mounted in the vehicle 1. In this case, one or more processors may correspond to a processor 510 of the computing device 50, and one or more memory devices may correspond to a memory 520 of the computing device 50. In some embodiments, the ventilation control apparatus 10 may include one or more non-transitory computer-readable media having computer-readable instructions stored thereon, and one or more processors configured to perform operations by executing the instructions. The operations may include configurations, functions, steps, or the like described in this specification with respect to a method and apparatus for controlling ventilation of a vehicle cargo compartment according to embodiments. In this specification, the term “module” is used in order to logically differentiate these operations performed by a method and apparatus for controlling ventilation of a vehicle cargo compartment according to embodiments.

The ventilation control apparatus 10 may be provided in the vehicle 1. The ventilation control apparatus 10 may exchange data with an integrated vehicle controller 20, that may also be provided the vehicle 1, via an internal network. In some embodiments, the internal network may include a controller area network (CAN), a local interconnect network (LIN), an automotive ethernet, and/or the like. The integrated vehicle controller 20 may be an apparatus configured to comprehensively manage and control various systems of the vehicle 1.

The ventilation control apparatus 10 may also exchange data with a remote server 30 via a network 40. The remote server 30 may be a server owned or serviced by a transportation company. For example, the vehicle 1 may be a goods delivery vehicle, and may communicate with the remote server 30 to receive various information including a goods delivery route, a goods delivery schedule, a goods delivery step, and/or the like. In addition, the vehicle 1 may provide various information on a goods delivery status and a state of the vehicle 1 to the remote server 30. The network 40 may include a wireless network, which may be implemented, for example, as a cellular network or a WiFi network.

The ventilation control apparatus 10 may include an operation mode setting module 110, a ventilation control module 120, an air cleaning control module 130, and a communication interface 140.

The operation mode setting module 110 may set an operation mode of the ventilation control. In some embodiments, the operation mode setting module 110 may select the operation mode from among a first operation mode, a second operation mode, and a third operation mode. The first operation mode may be an operation mode for performing the ventilation control by setting a ventilation mode to an outside air mode. The outside air mode is a method of bringing in the air from outside the vehicle and circulating it inside the vehicle, which can be a method in which the outside air is continuously brought into inside the vehicle and the air inside the vehicle is discharged. The second operation mode may be an operation mode for performing the ventilation control by setting the ventilation mode to an internal air circulation mode. The internal air circulation mode may be a mode in which the air inside the vehicle is circulated, so that the external air is not introduced and only the vehicle interior air continue to re-circulate. The third operation mode may be an operation mode for not performing the ventilation of the vehicle.

The operation mode setting module 110 may transmit location information of the vehicle 1 obtained from a location detecting device provided (e.g., mounted) in the vehicle 1 to the remote server 30, via the communication interface 140. In some embodiments, the location detecting device may include a global positioning system (GPS) device, but a method of obtaining the location information is not limited to a method of using the GPS device. The location information may be acquired, for example, through the location information shared from another vehicle via vehicle-to-everything (V2X) communication.

The operation mode setting module 110 may receive a plurality of remote data from the remote server 30, via the communication interface 140. Alternatively, the operation mode setting module 110 may receive the plurality of remote data from the integrated vehicle controller 20, via the internal network of the vehicle 1. The plurality of remote data may include a first remote data, a second remote data, a third remote data, and a fourth remote data.

The first remote data relates to whether an automatic ventilation control is activated. The first remote may include a value indicating an activation of the automatic ventilation control or a value indicating an inactivation of the automatic ventilation control. These values may be implemented as Boolean values, integer values, real number values, enumerated values, string values, bit flag values, or the like. The second remote data relates to a battery condition, where the battery may be a battery for driving an electric motor of the vehicle 1. The second remote data may include a value indicating the battery condition required for executing a function of controlling (e.g., automatically controlling) the ventilation of the vehicle cargo compartment according to the external environment. For example, the value indicating the battery condition may be a reference value indicating the battery state-of-charge or battery life-span. As described hereinbelow, the second remote data may be compared with a value representing a battery state of the vehicle 1. The third remote data may include information on a delivery zone. The information on the delivery zone may include information indicating a region in the vicinity of the garage location and the delivery location. For example, the third remote data may define regions, for example, by representing the address of the delivery location and the garage location in terms of latitude and longitude, or the like, considering the delivery route, delivery planning, or the like of the vehicle 1. As described hereinbelow, the third remote data may be used for determining whether a current delivery zone of the vehicle 1 belongs or corresponds to the defined region in the vicinity of the garage location and the delivery location. The fourth remote data may define a weather condition. For example, the fourth remote data may define the weather condition to include fine dust, cold waves, heat waves, heavy rain, heavy snow, and/or the like. As described hereinbelow, the fourth remote data may be used for determining whether the weather corresponds to the defined weather condition during driving of the vehicle 1.

Referring still to FIG. 1, the operation mode setting module 110 may receive a first local data, a second local data, a third local data, a fourth local data, and a fifth local data from the integrated vehicle controller 20, via the internal network of the vehicle 1. The first local data relates to the battery state of the vehicle 1. The first local data may include a currently measured value, for example, indicating the battery state-of-charge or battery life-span of the vehicle 1. The second local data relates to a refrigerator connection status of the vehicle 1. The second local data may include a value indicating that a refrigerator is connected to the vehicle 1 or a value indicating that the refrigerator is not connected to the vehicle 1. These values may be implemented as Boolean values, integer values, real number values, enumerated values, string values, bit flag values, or the like. The third local data relates to a driving state of the vehicle 1. The third local data may include, for example, a value indicating a current driving speed of the vehicle 1. The fourth local data relates to an air pollution level. The fourth local data may include, for example, a value indicating an air quality index numerically quantifies an air pollution status based on the concentration of pollutants in the air. The fifth local data relates to a fine dust level. The fifth local data may include, for example, a numerically quantifying value of the fine dust level based on diameters and concentration of the particles floating in the air.

The operation mode setting module 110 may determine whether a value of the first remote data indicates the activation of the automatic ventilation control. When it is determined that the value of the first remote data indicates the activation of the automatic ventilation control, the operation mode setting module 110 may determine whether a battery state of the first local data satisfies the battery condition of the second remote data. When it is determined that the battery state of the vehicle 1 of the first local data satisfies the battery condition of the second remote data, for example, when a battery state-of-charge of the vehicle 1 of the first local data is greater than or equal to a reference battery state-of-charge included in the battery condition, the operation mode setting module 110 may set the operation mode of the ventilation control to the first operation mode.

On the other hand, when it is determined (e.g., according to the logistics company's policy) that the value of the first remote data indicates the inactivation of the automatic ventilation control, the operation mode setting module 110 may set the operation mode of the ventilation control to the second operation mode. In an embodiment, the ventilation control operation in the second operation mode may be implemented to be different from the first operation mode. Accordingly, for example, when delivering goods that is not subject to damage under the automatic ventilation control, the automatic ventilation control may be activated, and when delivering goods that may be subject to damage under the automatic ventilation control, the automatic ventilation control may be inactivated.

In an embodiment, even if it is determined that the value of the first remote data indicates the activation of the automatic ventilation control, when it is determined that the battery state of the vehicle 1 of the first local data does not satisfy the battery condition of the second remote data, for example, when the battery state-of-charge of the vehicle 1 of the first local data is less than the reference battery state-of-charge included in the battery condition, the operation mode setting module 110 may set the operation mode of the ventilation control to the second operation mode.

The ventilation control module 120 may transmit a command to the integrated vehicle controller 20, so as to control the ventilation of the vehicle cargo compartment in different ways according to the operation mode set by the operation mode setting module 110. In some embodiments, when the operation mode of the ventilation control is the first operation mode, the ventilation control module 120 may transmit a command to the integrated vehicle controller 20, so as to control the ventilation of the vehicle cargo compartment by setting the ventilation mode to the outside air mode. In some embodiments, when the operation mode of the ventilation control is the second operation mode, the ventilation control module 120 may transmit a command to the integrated vehicle controller 20, so as to control the ventilation of the vehicle cargo compartment by setting the ventilation mode to the internal air circulation mode. Of course, the operation mode of the ventilation control is not limited to the operation method described herein, and may vary depending on a detailed implementation purpose.

In some embodiments, the operation mode setting module 110 may determine whether the current delivery zone of the vehicle 1 belongs or corresponds to the region in the vicinity of the garage location and the delivery location of the third remote data. When it is determined that the current delivery zone of the vehicle 1 belongs or corresponds to the region in the vicinity of the garage location and the delivery location of the third remote data, the operation mode setting module 110 may switch the operation mode of the ventilation control from the first operation mode to the third operation mode for not performing the ventilation of the vehicle. Accordingly, ventilation operation can be turned off in environments where ventilation is unnecessary due to frequent door opening and closing, such as delivery locations, or in environments where ventilation is not required, such as garages. The ventilation control module 120 may transmit a command to the integrated vehicle controller 20, so as to control the ventilation of the vehicle cargo compartment according to the third operation mode set by the operation mode setting module 110. In some embodiments, the operation mode setting module 110 may determine whether a weather corresponds to the weather condition of the fourth remote data while driving the vehicle 1. For example, the weather condition may include fine dust, cold waves, heat waves, heavy rain, heavy snow, and/or the like. When it is determined that the weather corresponds to the weather condition of the fourth remote data while driving the vehicle 1, the operation mode setting module 110 may switch the operation mode of the ventilation control from the first operation mode to the second operation mode. The ventilation control module 120 may transmit a command to the integrated vehicle controller 20, so as to control the ventilation of the vehicle cargo compartment according to the second operation mode set by the operation mode setting module 110. Accordingly, the circulation of outside air may be blocked, for example in situations where the air inside the vehicle 1 may become polluted due to ventilation, or where wind and rain may blow in.

In some embodiments, the operation mode setting module 110 may determine whether the value indicating the refrigerator connection status of the second local data indicates that the refrigerator is connected. When it is determined that the value indicating the refrigerator connection status of the second local data represents “being connected”, e.g., when the cargo compartment is implemented to include a refrigerator, the operation mode setting module 110 may switch the operation mode of the ventilation control from the first operation mode to the second operation mode. The ventilation control module 120 may transmit a command to the integrated vehicle controller 20, so as to control the ventilation of the vehicle cargo compartment according to the second operation mode set by the operation mode setting module 110. Accordingly, it is possible to prevent the cold air in the refrigerator from leaking outside or the cooling effect from decreasing.

In some embodiments, the operation mode setting module 110 may determine whether a value indicating a driving state of the third local data exceeds a predetermined reference speed. When it is determined that the value indicating the driving state of the third local data exceeds the predetermined reference speed, the ventilation control module 120 may transmit a command to the integrated vehicle controller 20 so as to open a door of a ventilation fan and operate the ventilation fan, for the ventilation of the vehicle cargo compartment. On the other hand, when it is determined that the value indicating the driving state of the third local data is smaller than or equal to the predetermined reference speed, the ventilation control module 120 may transmit a command to the integrated vehicle controller 20 so as to open only the door of the ventilation fan but not to operate the ventilation fan, for the ventilation of the vehicle cargo compartment. Accordingly, when the vehicle is driving at a speed of a certain level or more, the ventilation may be implemented without operating the ventilation fan, thereby achieving efficient ventilation control.

In some embodiments, when the operation mode of the ventilation control is the first operation mode, the operation mode setting module 110 may determine whether the air pollution level of the fourth local data is higher than a predetermined reference pollution level. When it is determined that the air pollution level of the fourth local data is higher than the predetermined reference pollution level, the air cleaning control module 130 may transmit a command to the integrated vehicle controller 20, so as to additionally perform the air cleaning control with respect to the vehicle cargo compartment. Accordingly, the air quality of the cargo compartment can be flexibly maintained to be clean, in consideration of air pollution degree.

In some embodiments, when the operation mode of the ventilation control is the first operation mode, the operation mode setting module 110 may determine whether the fine dust level of the fifth local data is higher than a predetermined fine dust reference level. When it is determined that the fine dust level of the fifth local data is higher than the predetermined fine dust reference level, the air cleaning control module 130 may transmit a command to the integrated vehicle controller 20, so as to additionally perform the air cleaning control with respect to the vehicle cargo compartment. Accordingly, the air quality of the cargo compartment can be flexibly maintained to be clean, in consideration of the fine dust level.

The operation mode setting module 110 may determine respective conditions according to a preset cycle, thereby precisely switching the operation mode of the ventilation control, and accordingly, (e.g., automatically) control ventilation of the cargo compartment by considering the external environment to maintain good air quality in the cargo compartment, and may prevent problems such as odor and pests that may occur during the logistics process effectively and efficiently.

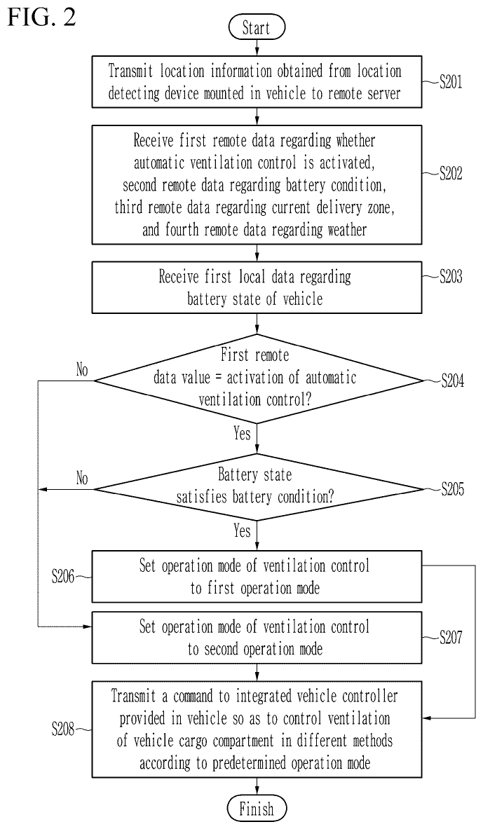

FIG. 2 is a drawing for explaining a method for controlling ventilation of a vehicle cargo compartment according to an embodiment.

Referring to FIG. 2, a method for controlling ventilation of a vehicle cargo compartment according to an embodiment may include: a step or operation S201 of transmitting location information obtained from the location detecting device mounted in vehicle to the remote server; a step or operation S202 of receiving the first remote data indicating whether the automatic ventilation control is activated, the second remote data indicating the battery condition, the third remote data including the information on the delivery zone, and the fourth remote data defining weather condition from the remote server; a step or operation S203 of receiving the first local data indicating the battery state of the vehicle; and a step or operation S204 of determining whether the value of the first remote data represents the activation of the automatic ventilation control.

When it is determined that the value of the first remote data represents the activation of the automatic ventilation control (Yes in the step or operation S204), the method may include performing a step or operation S205 of determining whether the battery state of the vehicle of the first local data satisfies the battery condition of the second remote data. When it is determined that the battery state of the vehicle of the first local data satisfies the battery condition of the second remote data (Yes in the step or operation S205), the method may include performing a step or operation S206 of setting the operation mode of the ventilation control to the first operation mode. In an embodiment, when the operation mode of the ventilation control is the first operation mode, the ventilation mode may be set to the outside air mode, to control the ventilation of the vehicle cargo compartment.

When it is determined that the value of the first remote data represents the inactivation of the automatic ventilation control (No in the step or operation S204) or when it is determined that the battery state of the vehicle of the first local data does not satisfy the battery condition of the second remote data (No in the step or operation S205), the method may include performing a step or operation S207 of setting the operation mode of the ventilation control to the second operation mode. In an embodiment, when the operation mode of the ventilation control is the second operation mode, the ventilation mode may be set to the internal air circulation mode, to control the ventilation of the vehicle cargo compartment.

The method may further include a step or operation S208 of transmitting a command to the integrated vehicle controller provided in the vehicle so as to control the ventilation of the vehicle cargo compartment in different methods according to the predetermined operation mode.

For more detailed information about the above method, reference can be made to the description of the embodiments described in this specification, so a redundant description is omitted here.

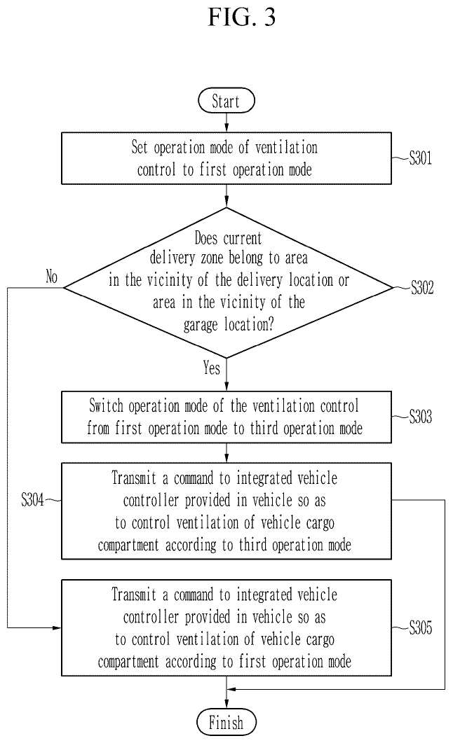

FIG. 3 is a drawing for explaining a method for controlling ventilation of a vehicle cargo compartment according to an embodiment.

Referring to FIG. 3, a method for controlling ventilation of a vehicle cargo compartment according to an embodiment may include: a step or operation S301 of setting the operation mode of the ventilation control to the first operation mode and a step or operation S302 of determining whether the current delivery zone belongs or corresponds to the region in the vicinity of the delivery location or the region in the vicinity of the garage location.

When it is determined that the current delivery zone belongs or corresponds to the region in the vicinity of the delivery location or the region in the vicinity of the garage location (Yes in the step or operation S302), the method may include performing a step or operation S303 of switching the operation mode of the ventilation control from the first operation mode to the third operation mode and a step or operation S304 of transmitting a command to the integrated vehicle controller provided in the vehicle so as to control the ventilation of the vehicle cargo compartment according to the third operation mode. In an embodiment, when the operation mode of the ventilation control is the third operation mode, ventilation of the vehicle may not be performed.

When it is determined that the current delivery zone does not belong or correspond to the region in the vicinity of the delivery location or the region in the vicinity of the garage location (No in the operation S302), the method may include performing a step or operation S305 of transmitting a command to the integrated vehicle controller provided in the vehicle so as to control the ventilation of the vehicle cargo compartment according to the first operation mode. In an embodiment, when the operation mode of the ventilation control is the first operation mode, the ventilation mode may be set to the outside air mode, to control the ventilation of the vehicle cargo compartment.

For more detailed information about the above method, reference can be made to the description of the embodiments described in this specification, so a redundant description is omitted here.

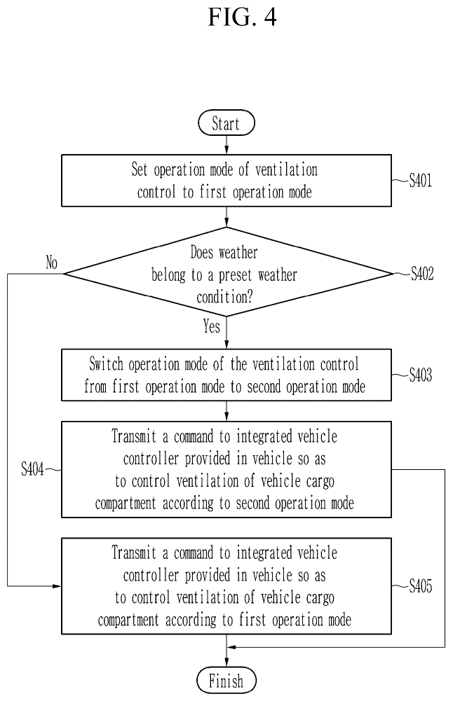

FIG. 4 is a drawing for explaining a method for controlling ventilation of a vehicle cargo compartment according to an embodiment.

Referring to FIG. 4, a method for controlling ventilation of a vehicle cargo compartment according to an embodiment may include a step or operation S401 of setting the operation mode of the ventilation control to the first operation mode and a step or operation S402 of determining whether a value indicating the weather condition corresponds to the preset weather condition (e.g., fine dust, cold waves, heat waves, heavy rain, heavy snow, or the like).

When it is determined that the value indicating the weather corresponds to the preset weather condition (Yes in the step or operation S402), the method may include performing a step or operation S403 of switching the operation mode of the ventilation control from the first operation mode to the second operation mode and a step or operation S404 of transmitting a command to the integrated vehicle controller provided in the vehicle so as to control the ventilation of the vehicle cargo compartment according to the second operation mode. In an embodiment, when the operation mode of the ventilation control is the second operation mode, the ventilation mode may be set to the internal air circulation mode, to control the ventilation of the vehicle cargo compartment.

When it is determined that the value indicating the weather condition does not correspond to the preset weather condition (No in the step or operation S402), the method may include performing a or operation step S405 of transmitting a command to the integrated vehicle controller provided in the vehicle so as to control the ventilation of the vehicle cargo compartment according to the first operation mode. In an embodiment, when the operation mode of the ventilation control is the first operation mode, the ventilation mode may be set to the outside air mode, to control the ventilation of the vehicle cargo compartment.

For more detailed information about the above method, reference can be made to the description of the embodiments described in this specification, so a redundant description is omitted here.

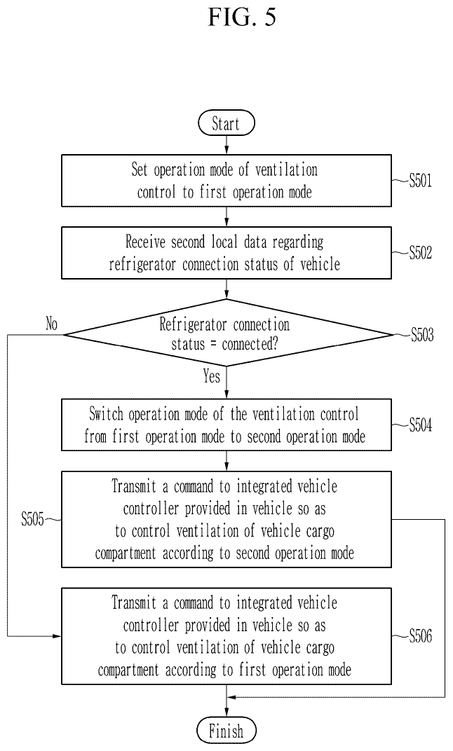

FIG. 5 is a drawing for explaining a method for controlling ventilation of a vehicle cargo compartment according to an embodiment.

Referring to FIG. 5, a method for controlling ventilation of a vehicle cargo compartment according to an embodiment may include a step or operation S501 of setting the operation mode of the ventilation control to the first operation mode, a step or operation S502 of receiving the second local data indicating the refrigerator connection status of the vehicle, and a step or operation S503 of determining whether the value indicating the refrigerator connection status indicates being connected.

When it is determined that the value indicating the refrigerator connection status indicates being connected (Yes in the step or operation S503), the method may include performing a step or operation S504 of switching the operation mode of the ventilation control from the first operation mode to the second operation mode and a step or operation S505 of transmitting a command to the integrated vehicle controller provided in the vehicle so as to control the ventilation of the vehicle cargo compartment according to the second operation mode. In an embodiment, when the operation mode of the ventilation control is the second operation mode, the ventilation mode may be set to the internal air circulation mode, to control the ventilation of the vehicle cargo compartment.

When it is determined that the value indicating the refrigerator connection status does not indicates being connected (No in the step or operation S503), the method may include performing a step or operation S506 of transmitting a command to the integrated vehicle controller provided in the vehicle so as to control the ventilation of the vehicle cargo compartment according to the first operation mode. In an embodiment, when the operation mode of the ventilation control is the first operation mode, the ventilation mode may be set to the outside air mode, to control the ventilation of the vehicle cargo compartment.

For more detailed information about the above method, reference can be made to the description of the embodiments described in this specification, so a redundant description is omitted here.

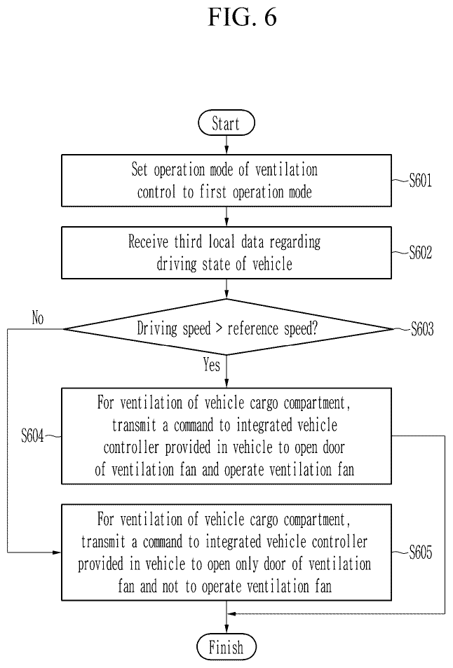

FIG. 6 is a drawing for explaining a method for controlling ventilation of a vehicle cargo compartment according to an embodiment.

Referring to FIG. 6, a method for controlling ventilation of a vehicle cargo compartment according to an embodiment may perform a step or operation S601 of setting the operation mode of the ventilation control to the first operation mode, a step or operation S602 of receiving the third local data indicative of the driving state of the vehicle, and a step or operation S603 of determining whether the driving state exceeds the predetermined reference speed.

When it is determined that the value indicating the driving state exceeds the predetermined reference speed (Yes in the step or operation S603), the method may include performing a step or operation S604 of transmitting a command to the integrated vehicle controller provided in the vehicle so as to door of open the ventilation fan and operate the ventilation fan, for the ventilation of the vehicle cargo compartment.

When it is determined that the value indicating the driving state does not exceed the predetermined reference speed (No in the step or operation S603), the method may include performing a step or operation S605 of transmitting a command to the integrated vehicle controller provided in the vehicle so as to open only the door of the ventilation fan but not to operate the ventilation fan, for the ventilation of the vehicle cargo compartment.

For more detailed information about the above method, reference can be made to the description of the embodiments described in this specification, so a redundant description is omitted here.

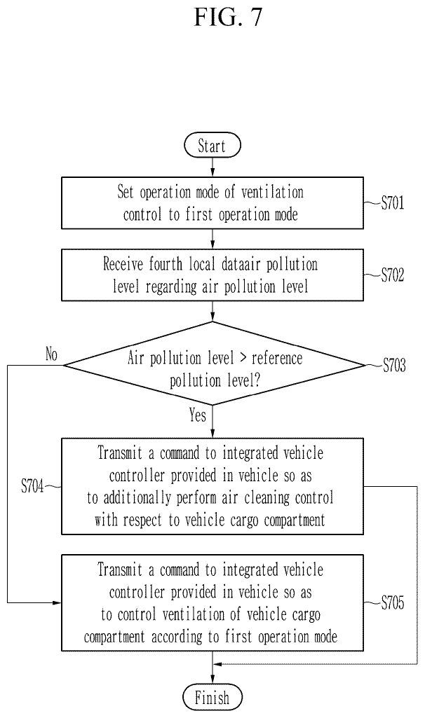

FIG. 7 is a drawing for explaining a method for controlling ventilation of a vehicle cargo compartment according to an embodiment.

Referring to FIG. 7, a method for controlling ventilation of a vehicle cargo compartment according to an embodiment may include a step or operation S701 of setting the operation mode of the ventilation control to the first operation mode, a step or operation S702 of receiving the fourth local data indicating the air pollution level, and a step or operation S703 of determining whether the air pollution level is higher than the predetermined reference pollution level.

When it is determined that the air pollution level is higher than the predetermined reference pollution level (Yes in the step or operation S703), the method may include performing a step or operation S704 of transmitting a command to the integrated vehicle controller provided in the vehicle so as to additionally perform the air cleaning control with respect to the vehicle cargo compartment.

When it is determined that the air pollution level is not higher than the predetermined reference pollution level (No in the step or operation S703), the method may include performing a step or operation S705 of transmitting a command to the integrated vehicle controller provided in the vehicle so as to control the ventilation of the vehicle cargo compartment according to the first operation mode.

For more detailed information about the above method, reference can be made to the description of the embodiments described in this specification, so a redundant description is omitted here.

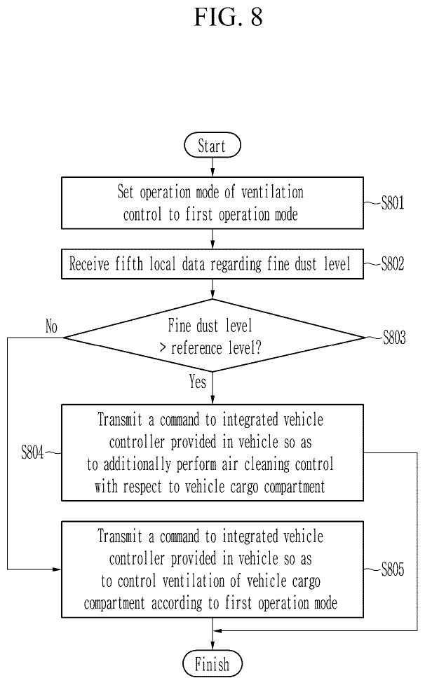

FIG. 8 is a drawing for explaining a method for controlling ventilation of a vehicle cargo compartment according to an embodiment.

Referring to FIG. 8, a method for controlling ventilation of a vehicle cargo compartment according to an embodiment may include a step or operation S801 of setting the operation mode of the ventilation control to the first operation mode, a step or operation S802 of receiving the fifth local data indicating the fine dust level, and a step or operation S803 of determining whether the fine dust level is higher than a predetermined fine dust reference level.

When it is determined that the fine dust level is higher than the predetermined fine dust reference level (Yes in the step or operation S803), the method may include performing a step or operation S804 of transmitting a command to the integrated vehicle controller provided in the vehicle so as to additionally perform the air cleaning control with respect to the vehicle cargo compartment.

When it is determined that the fine dust level is not higher than the predetermined fine dust reference level (No in the step or operation S803), the method may include performing a step or operation S805 of transmitting a command to the integrated vehicle controller provided in the vehicle so as to control the ventilation of the vehicle cargo compartment according to the first operation mode.

For more detailed information about the above method, reference can be made to the description of the embodiments described in this specification, so a redundant description is omitted here.

FIG. 9 is a drawing for explaining the computing device according to an embodiment.

Referring to FIG. 9, a method and apparatus for controlling ventilation of a vehicle cargo compartment according to embodiments may be implemented by using the computing device 50. The computing device 50 may be implemented as various types of electronic devices, servers or similar devices, and its function may be implemented through a combination of software and hardware.

The computing device 50 may include at least one of a processor 510, a memory 530, a user interface input device 540, a user interface output device 550 and a storage device 560 that communicate with each other through a bus 520. The computing device 50 may include a network interface 570 electrically connected to a network 40. The network interface 570 may send and/or receive signals to and from other entities through the network 40.

The processor 510 may be implemented as various types of calculation devices, such as a microcontroller unit (MCU), an application processor (AP), a central processing unit (CPU), a graphic processing unit (GPU), a neural processing unit (NPU), a quantum processing unit (QPU), etc. The processor 510 is also a semiconductor device that executes instructions stored in the memory 530 or the storage device 560 and may play a key role in the system. Program codes and data stored in the memory 530 or the storage device 560 instruct the processor 510 to perform specific tasks, thereby enabling the overall operation of the system. In this way, the processor 510 may be configured to implement the various functions and methods described above with reference to FIGS. 1-8.

The memory 530 and storage device 560 may include various forms of volatile or non-volatile storage medium for storing and accessing data of the system. For example, the memory 530 may include a read-only memory (ROM) 531 and a random-access memory (RAM) 532. In some embodiments, the memory 530 may be built into the processor 510, in which case data transmission speeds between the memory 530 and the processor 510 may be very fast. In some other embodiments, the memory 530 may be disposed external to the processor 510, in which case the memory 530 may be connected to the processor 510 through various data buses or interfaces. This connection may be made through a variety of known means—for example, a peripheral component interconnect express (PCIe) interface for high-speed data transmission or a memory controller.

In some embodiments, at least some components or functions of the ventilation control method and apparatus of the vehicle cargo compartment according to the embodiments may be implemented as the program or software executed by the computing device 50, and the program or software may be stored in a computer-readable recording or storage medium. Specifically, according to an embodiment, a computer-readable recording medium or storage medium may record a program for executing steps included in an implementation of the ventilation control method and apparatus of the vehicle cargo compartment according to embodiments, on a computer including the processor 510 executing a program or instructions stored in the memory 530 or the storage device 560.

In some embodiments, at least some configurations or functions of the ventilation control method and apparatus of the vehicle cargo compartment according to the embodiments may be implemented using hardware or circuit of the computing device 50, or may be implemented as separate hardware or circuit that may be electrically connected to computing device 50.

In some embodiments, one or more non-transitory computer-readable media including computer-readable instructions executable by the computing device 50 may be provided, and the computer-readable instructions may cause the computing device 50 to perform the operations, when executed by one or more processors of the computing device 50. In various embodiments, the operation may include configurations, functions, steps, or the like described in this specification in connection with a method and apparatus for controlling ventilation of a vehicle cargo compartment according to embodiments.

According to an embodiment, by controlling (e.g., automatically controlling) ventilation of the cargo compartment by considering the external environment, good air quality can be maintained in the cargo compartment, and problems such as odor and pests that may occur during the logistics process can be prevented.

While the present disclosure has been described in connection with example embodiments, it should be understood that the present disclosure is not limited to the described embodiments. Rather, the present disclosure is intended to cover various modifications and equivalent arrangements included within the spirit and scope of appended claims.

What is claimed is:

1. A method for controlling ventilation of a vehicle cargo compartment according to an external environment, the method comprising:
transmitting, by a processor of a vehicle, location information of the vehicle, obtained from a location detecting device provided in the vehicle, to a remote server;
receiving, by the processor, a first remote data indicating whether an automatic ventilation control is activated, a second remote data indicating a battery condition, and a third remote data comprising information on a delivery zone;
receiving, by the processor, a first local data indicating a battery state of the vehicle;
determining, by the processor, whether a value of the first remote data indicates an activation of the automatic ventilation control;
determining, by the processor, whether the battery state indicated by the first local data satisfies the battery condition indicated by the second remote data, based on determining that the value of the first remote data indicates the activation of the automatic ventilation control;
setting, by the processor, an operation mode of ventilation control, including
setting the operation mode of the ventilation control to a first operation mode, based on determining that the battery state of the vehicle of the first local data satisfies the battery condition indicated by the second remote data, and
setting the operation mode of the ventilation control to a second operation mode, based on determining one or both of i) that the value of the first remote data indicates an inactivation of the automatic ventilation control or ii) that the battery state of the vehicle of the first local data does not satisfy the battery condition of the second remote data; and
transmitting, by the processor, a command to an integrated vehicle controller provided in the vehicle to control the ventilation of the vehicle cargo compartment according to the operation mode of the ventilation control.

2. The method of claim 1, wherein transmitting the command to the integrated vehicle controller comprises transmitting, by the processor, a command to control the ventilation of the vehicle cargo compartment by setting a ventilation mode to an outside air mode, based on setting the operation mode of the ventilation control to the first operation mode.

3. The method of claim 1, wherein transmitting the command to the integrated vehicle controller comprises transmitting, by the processor, a command to control the ventilation of the vehicle cargo compartment by setting a ventilation mode to an internal air circulation mode, based on setting the operation mode to the second operation mode.

4. The method of claim 2, wherein:
the information on the delivery zone of the third remote data comprises information indicating a region in a vicinity of a garage location and a delivery location; and
the method further comprises:
determining, by the processor, whether a current delivery zone of the vehicle corresponds to the region in the vicinity of the garage location and the delivery location indicated by the third remote data,
switching, by the processor, the operation mode of the ventilation control from the first operation mode to a third operation mode for not performing ventilation of the vehicle, based on determining that the current delivery zone of the vehicle corresponds to the region in the vicinity of the garage location and the delivery location indicated by the third remote data; and
transmitting, by the processor, a command to the integrated vehicle controller to control the ventilation of the vehicle cargo compartment according to the third operation mode.

5. The method of claim 2, further comprising:
receiving, by the processor, a fourth remote data indicating a weather condition;
determining, by the processor, whether current weather during driving of the vehicle corresponds to the weather condition indicated by the fourth remote data;
switching, by the processor, the operation mode of the ventilation control from the first operation mode to the second operation mode, based on determining that the current weather during driving of the vehicle corresponds to the weather condition indicated by the fourth remote data; and
transmitting, by the processor, a command to the integrated vehicle controller to control the ventilation of the vehicle cargo compartment according to the second operation mode.

6. The method of claim 2, further comprising:
receiving, by the processor, a second local data indicating a refrigerator connection status of the vehicle;
switching, by the processor, the operation mode of the ventilation control from the first operation mode to the second operation mode, based on determining that a value of the second local data indicates that a refrigerator is connected; and
transmitting, by the processor, a command to the integrated vehicle controller to control the ventilation of the vehicle cargo compartment according to the second operation mode.

7. The method of claim 2, further comprising:
receiving, by the processor, a third local data indicating driving state of the vehicle;
determining, by the processor, whether a value of the third local data exceeds a predetermined reference speed; and
transmitting, by the processor, a command to the integrated vehicle controller to open a door of a ventilation fan and operate the ventilation fan, for the ventilation of the vehicle cargo compartment, based on determining that the value of the third local data exceeds the predetermined reference speed.

8. The method of claim 7, wherein transmitting the command to the integrated vehicle controller further comprises transmitting, by the processor, a command to open the door of the ventilation fan but not to operate the ventilation fan, for the ventilation of the vehicle cargo compartment, based on determining that the value of the third local data is less than or equal to the predetermined reference speed.

9. The method of claim 1, further comprising:
receiving, by the processor, a fourth local data indicating an air pollution level, when the operation mode of the ventilation control is the first operation mode;
determining, by the processor, whether the air pollution level of the fourth local data is higher than a predetermined reference pollution level; and
transmitting, by the processor, a command to the integrated vehicle controller to additionally perform an air cleaning control with respect to the vehicle cargo compartment, based on determining that the air pollution level indicated by the fourth local data is higher than the predetermined reference pollution level.

10. The method of claim 1, further comprising:
receiving, by the processor, a fifth local data indicating a fine dust level, when the operation mode of the ventilation control is the first operation mode;
determining, by the processor, whether the fine dust level indicated by the fifth local data is higher than a predetermined fine dust reference level; and
transmitting, by the processor, a command to the integrated vehicle controller to additionally perform an air cleaning control with respect to the vehicle cargo compartment, based on determining that the fine dust level of the fifth local data is higher than the predetermined fine dust reference level.

11. An apparatus for controlling ventilation of a vehicle cargo compartment of a vehicle according to an external environment, the apparatus comprising:
one or more non-transitory computer-readable media having computer-readable instructions stored thereon; and
one or more processors configured to execute the computer-readable instructions to:
transmit location information of the vehicle obtained to a remote server, via a communication interface,
receive a first remote data indicating whether an automatic ventilation control is activated, a second remote data indicating a battery condition, and a third remote data comprising information on a delivery zone, via the communication interface or a vehicle interior network,
receive a first local data indicating a battery state of the vehicle, via the vehicle interior network,
determine whether a value of the first remote data indicates an activation of the automatic ventilation control,
determine whether the battery state indicated by the first local data satisfies the battery condition indicated by the second remote data, based on determining that the value of the first remote data indicates the activation of the automatic ventilation control,
set an operation mode of ventilation control to a first operation mode, based on determining that the battery state of the vehicle indicated by the first local data satisfies the battery condition indicated by the second remote data,
set the operation mode of the ventilation control to a second operation mode, based on determining one or both i) that the value of the first remote data indicates an inactivation of the automatic ventilation control ii) that the battery state of the vehicle indicated by the first local data does not satisfy the battery condition indicated by the second remote data, and
transmit a command to an integrated vehicle controller provided in the vehicle to control the ventilation of the vehicle cargo compartment according to the operation mode of the ventilation control.

12. The apparatus of claim 11, wherein the one or more processors are configured to transmit the command to the integrated vehicle controller to control the ventilation of the vehicle cargo compartment by setting a ventilation mode to an outside air mode, based on setting the operation mode of the ventilation control to the first operation mode.

13. The apparatus of claim 11, wherein the one or more processors are configured to transmit the command the integrated vehicle controller to control the ventilation of the vehicle cargo compartment by setting a ventilation mode to an internal air circulation mode, based on setting the operation mode of the ventilation control to the second operation mode.

14. The apparatus of claim 12, wherein:
the information on the delivery zone of the third remote data comprises information indicating a region in a vicinity of a garage location and a delivery location; and
the one or more processors are further configured to execute the computer-readable instructions to:
determine whether a current delivery zone of the vehicle corresponds to the region in the vicinity of the garage location and the delivery location indicated by the third remote data,
switch the operation mode of the ventilation control from the first operation mode to a third operation mode for not performing the ventilation of the vehicle, based on determining that the current delivery zone of the vehicle corresponds to the region in the vicinity of the garage location and the delivery location indicated by the third remote data, and
transmit a command to the integrated vehicle controller to control the ventilation of the vehicle cargo compartment according to the third operation mode.

15. The apparatus of claim 12, wherein the one or more processors are further configured to execute the computer-readable instructions to:
receive a fourth remote data indicating a weather condition, via the communication interface or the vehicle interior network;
determine whether current weather during driving of the vehicle corresponds to the weather condition indicated by the fourth remote data;
switch the operation mode of the ventilation control from the first operation mode to the second operation mode, based on determining that the current weather during driving of the vehicle corresponds to the weather condition indicated by the fourth remote data; and
transmit a command to the integrated vehicle controller to control the ventilation of the vehicle cargo compartment according to the second operation mode.

16. The apparatus of claim 12, wherein the one or more processors are further configured to execute the computer-readable instructions to:
receive a second local data indicating a refrigerator connection status of the vehicle, via the vehicle interior network;
switch the operation mode of the ventilation control from the first operation mode to the second operation mode, based on determining that a value of the second local data indicated that a refrigerator is connected; and
transmit a command to the integrated vehicle controller to control the ventilation of the vehicle cargo compartment according to the second operation mode.

17. The apparatus of claim 12, wherein the one or more processors are further configured to execute the computer-readable instructions to:
receive a third local data indicating driving state of the vehicle, via the vehicle interior network;
determine whether a value of the third local data exceeds a predetermined reference speed;
transmit a command to the integrated vehicle controller to open a door of a ventilation fan and operate the ventilation fan, for the ventilation of the vehicle cargo compartment, based on determining that the value of the third local data exceeds the predetermined reference speed; and
transmit a command to the integrated vehicle controller to open the door of the ventilation fan but not operate the ventilation fan, for the ventilation of the vehicle cargo compartment, based on determining that the value of the third local data is less than or equal to the predetermined reference speed.

18. The apparatus of claim 11, wherein the one or more processors are further configured to execute the computer-readable instructions to:
receive a fourth local data indicating an air pollution level, via the vehicle interior network, when the operation mode of the ventilation control is the first operation mode;
determine whether the air pollution level indicated by the fourth local data is higher than a predetermined reference pollution level; and
transmit a command to the integrated vehicle controller to additionally perform an air cleaning control with respect to the vehicle cargo compartment, based on determining that the air pollution level indicated by the fourth local data is higher than the predetermined reference pollution level.

19. The apparatus of claim 11, wherein the one or more processors are further configured to execute the computer-readable instructions to:
receive a fifth local data indicating a fine dust level, via the vehicle interior network, when the operation mode of the ventilation control is the first operation mode;
determine whether the fine dust level indicated by the fifth local data is higher than a predetermined fine dust reference level; and
transmit a command to the integrated vehicle controller to additionally perform an air cleaning control with respect to the vehicle cargo compartment, based on determining that the fine dust level indicated by the fifth local data is higher than the predetermined fine dust reference level.

20. One or more non-transitory computer-readable media storing computer-readable instructions that, when executed by one or more processors, cause the one or more processors to:
transmit location information of a vehicle, obtained from a location detecting device provided in the vehicle, to a remote server;
receive a first remote data indicating whether an automatic ventilation control is activated, a second remote data indicating a battery condition, and a third remote data comprising information on a delivery zone;
receive a first local data indicating a battery state of the vehicle;
determine whether a value of the first remote data indicates an activation of the automatic ventilation control;
determine whether the battery state indicated by the first local data satisfies the battery condition indicated by the second remote data, when it is determined that the value of the first remote data indicates the activation of the automatic ventilation control;
set an operation mode of ventilation control to a first operation mode, based on determining that the battery state of the vehicle indicated by the first local data satisfies the battery condition indicated by the second remote data;
set the operation mode of the ventilation control to a second operation mode, based on determining one or both i) that the value of the first remote data indicates an inactivation of the automatic ventilation control or ii) that the battery state of the vehicle indicated by the first local data does not satisfy the battery condition indicated by the second remote data; and
transmit a command to an integrated vehicle controller provided in the vehicle to control ventilation of a vehicle cargo compartment of the vehicle according to the operation mode of the ventilation control.
